(19) United States
(12) Patent Application Publication
(10) Pub. No.: US 2023/0302569 A1
(43) Pub. Date: Sep. 28, 2023

(54) DEBURRING TOOL

(71) Applicant: HONDA MOTOR CO., LTD., Tokyo (JP)

(72) Inventors: Satoshi Matsuura, Tokyo (JP); Toshihide Sunada, Tokyo (JP); Atsuhiro Hatanaka, Tokyo (JP); Yoshihiro Kikima, Tokyo (JP)

(73) Assignee: HONDA MOTOR CO., LTD., Tokyo (JP)

(21) Appl. No.: 18/113,430

(22) Filed: Feb. 23, 2023

(30) Foreign Application Priority Data
Mar. 28, 2022 (JP) 2022-052442

(51) Int. Cl. B23K 20/12; B23K 37/08

(52) U.S. Cl. CPC B23K 20/1255; B23K 37/08

(57) ABSTRACT

A deburring tool for cutting burr generated when members are welded to each other by friction stir welding is provided. The deburring tool includes a tool center portion contacting a welding portion, and a blade portion formed on an outer circumference of the tool center portion to cut the burr. The tool center portion includes a protrusion protruding downward from a ridge line of the blade portion to control a burr cutting amount.

### CROSS-REFERENCE TO RELATED APPLICATION(S)

This application claims priority to and the benefit of Japanese Patent Application No. 2022-052442 filed on Mar. 28, 2022, the entire disclosure of which is incorporated herein by reference.

### BACKGROUND OF THE INVENTION

### Field of the Invention

The present invention relates to a technology for removing burr generated by friction stir welding.

### Description of the Related Art

As a method for welding two members to each other, there has been known friction stir welding (hereinafter also referred to as “FSW”) in which the two members are welded to each other by softening a welding portion between the two members due to frictional heat and stirring the softened welding portion. The FSW is performed by rotating a tool (pin) while strongly pressing the tool against the welding portion. Therefore, a portion of a member to be welded that has plastically flowed is solidified, and so-called “burr” remains in the welding portion (bead). Since the burr damages an appearance of a product, causes corrosion, and further causes a cut wound to an operator and a user, a burr removing process is essential in the FSW.

Conventionally, the burr removing process includes a type in which the burr removing process is performed during welding (e.g., Japanese Patent Laid-Open No. 2001-47262) or a type in which the burr removing process is performed after welding. The type in which the burr removing process is performed during welding is advantageous from the viewpoint of improving productivity because deburring can be performed simultaneously with FSW, but it is likely that cutting may be excessively performed or the burr may remain, and it is often that satisfactory burr removing accuracy cannot be obtained. On the other hand, the type in which the burr removing process is performed after welding is disadvantageous from the viewpoint of productivity because deburring needs to be performed as a post-process, but high deburring accuracy can be expected. The present invention aims to further improve deburring accuracy in the type in which the burr removing process is performed after welding. Unexamined Japanese Utility Model Laid-Open No. 61-105513 discloses a chamfering tool that is not limited to deburring, and this can be applied for deburring in a post-process of FSW. In Japanese Utility Model Laid-Open No. 61-105513, a chamfering amount adjustment stopper 16 for determining a chamfering depth is provided on an outer circumference of the tool, that is, outside a cutting blade 12. By moving the tool on the welding portion while the chamfering amount adjustment stopper 16 functions as a copying portion, a chamfering process can be performed without excessive cutting.

However, in the FSW, the burr is generated at an end portion of the bead. Therefore, in a case where a chamfering amount adjustment stopper is provided outside a cutting blade as in Japanese Utility Model Laid-Open No. 61-105513, the chamfering amount adjustment stopper interferes with burr. Therefore, if FSW deburring is performed with the tool as disclosed in Japanese Utility Model Laid-Open No. 61-105513, the chamfering amount adjustment stopper does not function as a copying portion, that is, the tool is moved along the bead in a state where a cutting blade is brought into contact with the burr at a height at which the chamfering amount adjustment stopper is lifted from the bead. In this case, a burr residue cannot be avoided, and highly accurate deburring cannot be performed.

### SUMMARY OF THE INVENTION

In view of such a problem, an object of the present invention is to provide a technology advantageous for improving accuracy in removing burr generated by friction stir welding.

The present disclosure in its one aspect provides a deburring tool for cutting burr generated when members are welded to each other by friction stir welding, the deburring tool including a tool center portion contacting a welding portion, and a blade portion formed on an outer circumference of the tool center portion to cut the burr, wherein the tool center portion includes a protrusion protruding downward from a ridge line of the blade portion to control a burr cutting amount.

Further features of the present invention will become apparent from the following description of exemplary embodiments (with reference to the attached drawings).

### BRIEF DESCRIPTION OF THE DRAWINGS

FIGS. 1A and 1B are views for explaining friction stir welding;

FIG. 2 is a view illustrating an example of a configuration of a deburring system;

FIGS. 3A and 3B are views illustrating an example of a configuration around a blade portion of a deburring tool;

FIG. 4 is a view illustrating a cross-sectional shape of the blade portion of the deburring tool;

FIGS. 5A and 5B are views for explaining an advantage of the deburring tool;

FIG. 6 is a view illustrating an example of a floating mechanism of the deburring tool;

FIG. 7 is a view illustrating an example in which a protrusion is fixed by bolts;

FIGS. 8A and 8B are views illustrating an example of a method for adjusting a protruding amount of the protrusion; and

FIG. 9 is a view illustrating an example of a shape of a connection portion between a tool center portion and a blade portion.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

In the present specification and the drawings, directions are indicated in an XYZ coordinate system in which a horizontal plane is an XY plane. Hereinafter, directions parallel to an X axis, a Y axis, and a Z axis in the XYZ coordinate system will be referred to as an X direction, a Y direction, and a Z direction, respectively.

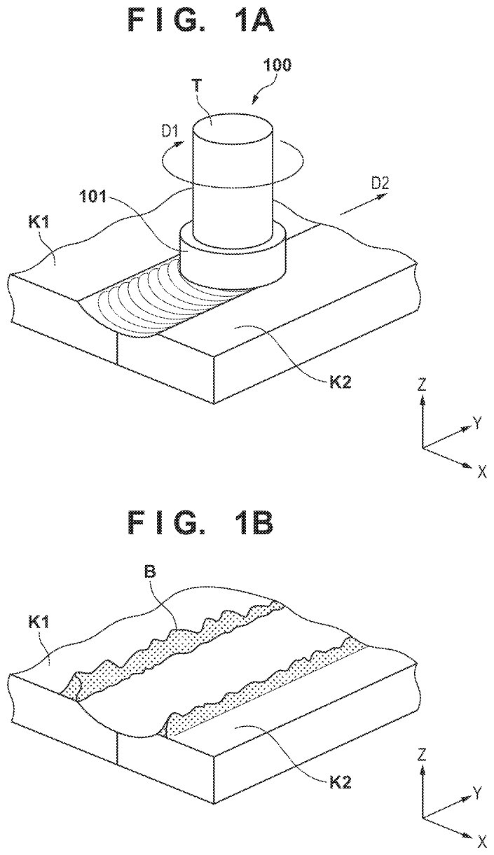

FIG. 1A illustrates how members are welded to each other by friction stir welding (FSW). Here, a first member K1 and a second member K2 are welded to each other. The first member K1 and the second member K2 may be made of the same material or different materials. For example, the first member K1 and the second member K2 may be different types of metals. Alternatively, one of the first member K1 and the second member K2 may be metal, and the other may be other than metal (e.g., resin). It is assumed that the first member K1 and the second member K2 abut each other in the X direction, and contact surfaces of the two members extend in the Y direction.

The FSW is performed by moving a probe 101 of an FSW tool 100 in the Y direction in which a welding portion between the first member K1 and the second member K2 extends (a direction indicated by an arrow D2), in a state where a distal end of the probe 101 of the FSW tool 100 is pressed against the welding portion, while rotating the probe 101 in a rotation direction (a θz direction) around the Z axis indicated by an arrow D1. By pressing the distal end of the probe 101 against the welding portion while rotating the distal end of the probe 101, the first member K1 and the second member K2 around the welding portion are softened by frictional heat and plastically flows. As a result, the two members are integrated to realize welding.

In the FSW, as illustrated in FIG. 1B, a portion of the member that has plastically flowed remains as a burr B along both end portions of the welding portion (bead). The deburring tool according to the present embodiment successfully removes the burr B remaining by the FSW as described above.

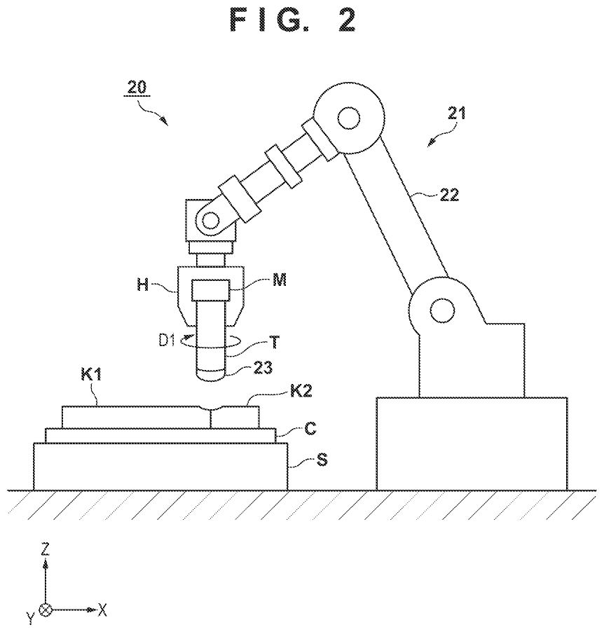

FIG. 2 illustrates an example of a configuration of a deburring system 20 according to an embodiment. The deburring system 20 includes a robot 21.

The robot 21 includes an articulated arm 22 that can be driven, for example, about six axes. A deburring tool T is supported at a distal end of the arm 22 via a hand H. In addition, a rotation motor M for rotating a blade portion 23 attached to a lower end of the deburring tool T in the θz direction indicated by the arrow D1 is attached to an upper end of the deburring tool T. The first member K1 and the second member K2, which are welded to each other by FSW as workpieces, are fixed onto a stage S (a surface plate) via a chuck C. (A control unit, although not illustrated, of) the robot 21 controls the arm 22 to move the deburring tool T on the bead, thereby performing deburring. Note that the robot 21 is described herein as a serial link type robot using an articulated arm, but may be a parallel link type robot that operates an object via a parallel link mechanism including a plurality of arms.

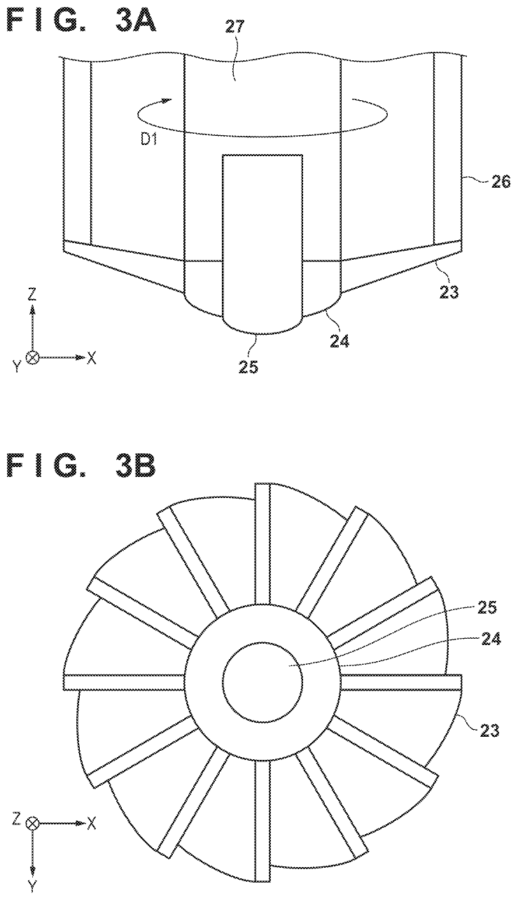

FIG. 3A is a cross-sectional view of a main portion around the blade portion 23 of the deburring tool T, and FIG. 3B is a plan view of the blade portion 23 as viewed from below.

A rotation shaft 27 connected coaxially with an output shaft of the rotation motor M is disposed at the center inside a tool body 26. The rotation shaft 27 extends in the Z direction and can rotate in the θz direction indicated by the arrow D1 by a driving force of the rotation motor M. A tool center portion 24 is fixed to a distal end (a lower end) of the rotation shaft 27. The blade portion 23 is formed on an outer circumference of the tool center portion 24. The tool center portion 24 is a base end portion (a root) of the blade portion 23, and the tool center portion 24 and the blade portion 23 may be integrally formed, or may be formed separately (detachably). The tool body 26 forms a housing accommodating the rotation shaft 27, and a lower end of the tool body 26 and a distal end of the blade portion 23 may be fixed to each other as illustrated in FIG. 3A or may be integrally formed. By doing so, the tool body 26 can also function as a support member that prevents the blade portion 23 from being chipped. In this case, the tool body 26 rotates as the rotation shaft 27 (that is, the blade portion 23) rotates. However, the lower end of the tool body 26 and the distal end of the blade portion 23 may not be connected to each other, and in this case, the tool body 26 does not rotate as the rotation shaft 27 (that is, the blade portion 23) rotates. In FIG. 3B, the blade portion 23 has 12 blades, but the present invention is not limited to a specific number of blades. The number of blades can be appropriately selected according to a feed rate of the deburring tool T, a rotation speed of the blade portion 23, materials of the first and second members, and the like. As described above, the tool center portion 24 and the blade portion 23 may be formed separately, and the tool body 26 and the blade portion 23 may be formed separately. Therefore, the blade portion 23, the tool center portion 24, the tool body 26, and a protrusion 25 to be described below may be formed separately or integrally.

The tool center portion 24 has a protrusion 25 at the rotation center thereof. The protrusion 25 has a convex shape by protruding downward from a ridge line of the blade portion 23 to control a burr cutting amount. In a deburring process, the robot 21 controls the arm 22 to position the deburring tool T so that the protrusion 25 abuts the welding portion (bead). Then, deburring is performed by moving the deburring tool T along the bead in a state where the protrusion 25 is brought in contact with the bead. That is, the protrusion 25 functions as a copying portion during copying processing as deburring. The presence of the copying portion prevents excessive cutting.

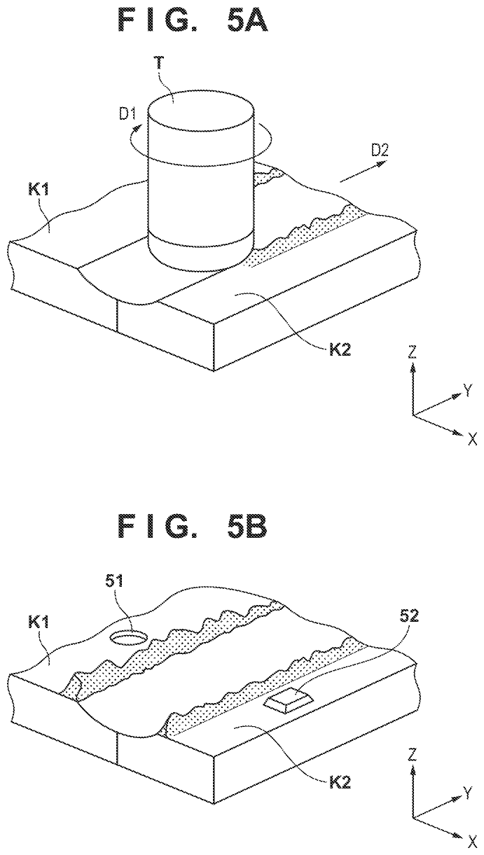

In the FSW, when the probe 101 is rotated in the D1 direction as illustrated in FIG. 1A, it is likely that a lot of burr B occurs on a left side of a welding progress direction (the D2 direction (the Y direction) in FIG. 1A) as illustrated in FIG. 1B. In order not to leave the burr on the bead, as illustrated in FIGS. 3A and 5A, the rotation direction of the deburring tool T (the blade portion 23) may be the same as the rotation direction of the FSW tool 100 (the probe 101), i.e., the D1 direction, and the movement direction of the deburring tool T may be the same as the welding processing progress, i.e., the D2 direction.

The function of the protrusion 25 as a copying portion makes it possible to appropriately control a lowered amount of the deburring tool T. As a result, it is possible to prevent excessive cutting and reduce a burr residue, and it is also possible to control a lowered amount regardless of a shape of a workpiece.

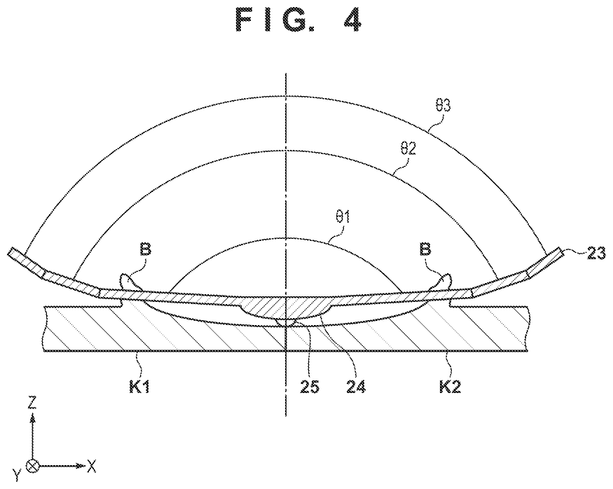

Further, in a chamfering tool as disclosed in Japanese Utility Model Laid-Open No. 61-105513, a chamfering amount adjustment stopper, which is a copying portion, is provided outside a blade portion. Therefore, by moving the chamfering tool along bead of FSW, the chamfering amount adjustment stopper interferes with burr, and the burr cannot be scraped off. Further, FIG. 4 of Japanese Patent No. 6846075 discloses a configuration in which a blade is disposed to move along a surface of a workpiece, and the blade is driven in a direction orthogonal to a machining progress direction. In such a configuration, when there is a hole 51 or a boss 52 near the bead as illustrated in FIG. 5B, the blade interferes with the hole and the boss, and deburring cannot be performed at that portion.

In contrast, in the present embodiment, since the protrusion 25, which is a copying portion, exists inside the blade portion 23, the protrusion 25 does not interfere with burr, and the blade portion 23 and the protrusion 25 do not interfere with a hole or a boss near bead, so that the burr can be reliably removed.

As described above, since deburring is performed by moving the deburring tool T along the bead in a state where the protrusion 25 is brought in contact with the welding portion (the bead), the protrusion 25 functions as a copying portion. Therefore, it is possible to cope with not only a case where the welding surface is flat but also a case where the welding surface has an uneven profile in the height direction. That is, even when the welding surface extending in the Y direction has different heights at different positions in the Y direction, the protrusion 25 abuts the welding surface while copying the welding surface, thereby making it possible to perform deburring with the same accuracy at any position. In addition, the bead may have a depth that is not constant and varies by portion in the progress direction. The deburring tool T may include a floating mechanism for absorbing such variations in bead depth.

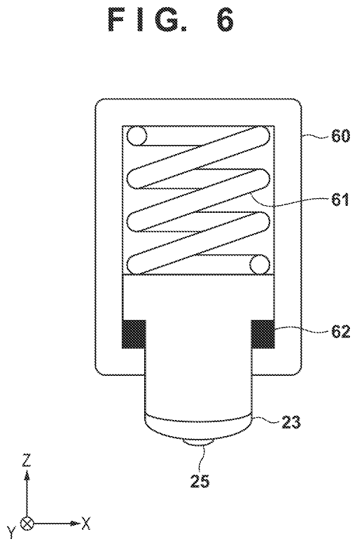

FIG. 6 illustrates an example of the floating mechanism. The tool body 26 is accommodated in a housing 60 so that the blade portion 23 and the protrusion 25 attached to the lower end thereof are exposed. The tool body 26 is movable (slidable) in the Z direction along an inner wall of the housing 60. A compression spring 61 is mounted between an upper surface of the tool body 26 and an inner wall of an upper surface of the housing 60 facing each other, and the tool body 26 is biased in a direction toward the distal end (the lower end) thereof by the compression spring 61. In addition, a buffer member 62 such as a rubber bush may be disposed between a peripheral portion of an inner wall of an opening formed in a bottom portion of the housing 60 and a head portion of the tool body 26. Note that, for simplification of the drawing, the rotation shaft 27 (see FIG. 3A) inserted into the compression spring 61, a mechanism for expanding or contracting the compression spring 61, and the like are omitted in FIG. 6. Further, another elastic member such as an air spring may be used instead of the compression spring 61.

The deburring tool T moves in the progress direction while the compression spring 61 expands or contracts according to a variation in bead depth. Therefore, even if the deburring tool T is moved at a constant height in the progress direction, the height of the blade portion 23 can be displaced in accordance with the variation in bead depth, such that deburring can be performed with high accuracy.

During the copying processing, since the protrusion 25 moves while rotating on the bead, sliding friction between the protrusion 25 and the bead is inevitable. Therefore, for example, in a case where aluminum is contained in the first member K1 and/or the second member K2, there is a possibility that the aluminum may adhere to the protrusion 25 contacting the bead. Therefore, in an example, the convex shape of the protrusion 25 is formed by protruding downward in an arc shape from the ridge line of the blade portion 23. By forming the protrusion 25 in an arc shape, the contact between the protrusion 25 and the bead approximates a point contact, so that slipperiness is improved, making it possible to prevent or reduce adhesion of aluminum as described above.

FIG. 4 illustrates an example of a cross-sectional shape of bead formed by the FSW and a cross-sectional shape of the blade portion 23 corresponding thereto. As illustrated in FIG. 4, the bead formed by the FSW typically has a shape in which a central portion thereof is recessed by coagulation shrinkage. The protrusion 25 abuts such a recessed position of the central portion of the bead, and the blade portion 23 cuts burr B generated at an end portion of the bead. The blade portion 23 has a distal end angle corresponding to such a cross-sectional shape of the bead.

In the present embodiment, as illustrated in FIG. 4, the blade portion 23 has a shape in which a distal end angle (a taper angle) decreases toward an outer circumference thereof in a radial direction. For example, the blade portion 23 satisfies the following relationship between θ1, θ2, and θ3, θ1 being a distal end angle of a first region on an inner circumference side close to the tool center portion 24, θ2 being a distal end angle of a second region on an outer circumference side of the first region, θ3 being a distal end angle of a third region on an outer circumference side of the second region.

θ1>θ2>θ3

By reducing the distal end angles in a stepwise manner in an outward direction as described above, it is possible to prevent a workpiece portion outside the burr B generated at the end portion of the bead from being scraped.

In the present embodiment, the blade portion 23 and at least the protrusion 25, preferably the tool center portion 24 including the protrusion 25, may be coated with diamond-like carbon (DLC). The DLC films formed on the blade portion 23 and the protrusion 25 may be formed of the same material. In an example, the material of the DLC film may be hydrogen-free DLC.

The formation of the DLC film on the surface of the protrusion 25 is to secure smoothness of sliding between the protrusion 25 and the bead, and the formation of the DLC film on the surface of the blade portion 23 is to secure high hardness against the burr B to be cut. Therefore, the materials of the two DLC films may be different according to the difference in purpose therebetween. In an example, amorphous carbon (a-C) excellent in low friction (sliding resistance) can be selected as the DLC film formed on the surface of the protrusion 25, and tetrahedral amorphous carbon (ta-C) having higher hardness than a-C can be selected as the DLC film formed on the surface of the blade portion 23. In this case, the DLC film formed on the surface of the protrusion 25 has a lower friction coefficient than the DLC film formed on the blade portion 23. In addition, the DLC film formed on the blade portion 23 has higher hardness than the DLC film of the protrusion 25. Although it has been described in the above-described example that DLC is used as a coating material, the coating material is not limited to DLC. For example, titanium nitride (TiN), chromium nitride (CrN), or the like may be used as the coating material.

By using a coating suitable for each portion of the deburring tool T as described above, the lifespan of each portion of the deburring tool T can be prolonged.

Even though the protrusion 25 is coated with DLC as described above, a thermal load on the protrusion 25 is large, and there is still possibility that aluminum may be deposited on the protrusion 25. Therefore, the protrusion 25 and the blade portion 23 may be formed separately. In this case, the protrusion 25 and the tool center portion 24 may be formed separately. In this way, since only the protrusion 25 having a large thermal load can be replaced, cost reduction can be achieved.

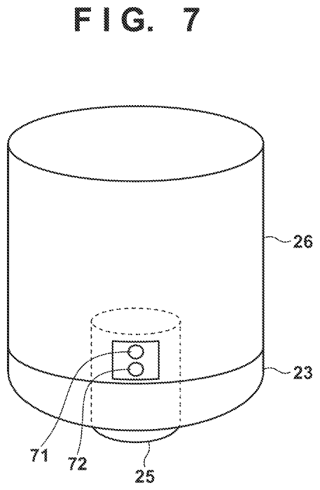

When the protrusion 25 and the tool center portion 24 are formed separately, the protrusion 25 may be fixed to a surface of the tool body 26 by bolts 71 and 72 as illustrated in FIG. 7. Such a configuration makes it possible for the user to easily attach and detach the protrusion 25. In addition, a protruding amount of the protrusion 25 with respect to the ridge line of the blade portion 23 may be adjusted depending on how much the bolt 71 and/or the bolt 72 is tightened.

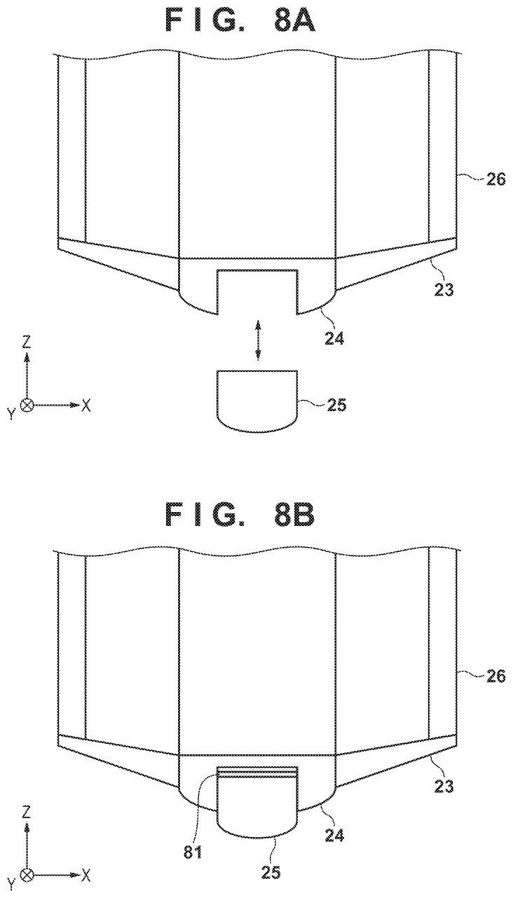

FIG. 8A illustrates a state in which the protrusion 25 is removed from the tool center portion 24. When the protrusion 25 is attached, a protruding amount of the protrusion 25 with respect to the ridge line of the blade portion 23 may be adjusted by interposing one or more spacers or shims 81 as illustrated in FIG. 8B. By making the protruding amount adjustable as described above, it is possible to obtain an adjustment amount of the protrusion 25 according to a welding depth.

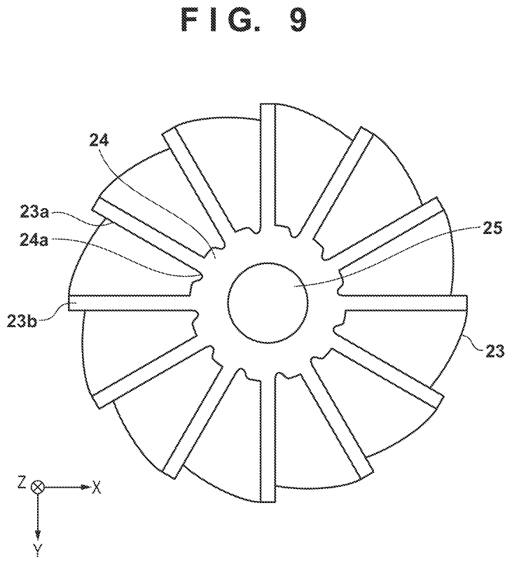

FIG. 9 illustrates an example of a shape of a connection portion between the tool center portion 24 and the blade portion 23. In the example of FIG. 9, a groove 24a positioned between a flank surface 23b of a cutting blade of the blade portion 23 and a cutting blade (a rake surface) 23a following the flank surface 23b is formed to reach an outer circumferential portion of the tool center portion 24. The groove 24a makes it possible to improve air permeability between cutting blades, and obtain a heat dissipation effect. In addition, since the burr is located away from the protrusion 25 and the chips scattered by cutting are discharged to the outer circumferential portion, there is no possibility that the chips enter a dividing surface between the protrusion 25 and the tool center portion 24 (a dividing surface between the blade portion 23 and the tool center portion 24 in a case where the blade portion 23 and the tool center portion 24 are divided from each other) and the dividing portion cannot be removed.

### Summary of Embodiments

The above embodiments disclose at least the following embodiments of the deburring tool.

1. A deburring tool (T) for cutting burr generated when members are welded to each other by friction stir welding, the deburring tool including:
a tool center portion (24) contacting a welding portion; and
a blade portion (23) formed on an outer circumference of the tool center portion to cut the burr,
wherein the tool center portion includes a protrusion (25) protruding downward from a ridge line of the blade portion to control a burr cutting amount.

According to this embodiment, it is possible to appropriately control a lowered amount of the deburring tool, prevent excessive cutting and reduce a burr residue, and control a lowered amount regardless of a shape of a workpiece.

2. The deburring tool according to the item 1, wherein the protrusion protrudes downward from the ridge line of the blade portion in an arc shape.

According to this embodiment, since the contact between the protrusion and the welding portion approximates a point contact, slipperiness is improved, making it possible to prevent or reduce adhesion of aluminum.

3. The deburring tool according to the item 1, wherein the blade portion has a shape in which a distal end angle decreases toward an outer circumference thereof in a radial direction.

According to this embodiment, it is possible to prevent a workpiece portion outside the burr from being scraped.

4. The deburring tool according to the item 1, wherein a diamond-like carbon film is formed on a surface of each of the protrusion and the blade portion, and
the diamond-like carbon film of the protrusion has a lower friction coefficient than the diamond-like carbon film of the blade portion.

According to this embodiment, a coating suitable for each location of the deburring tool is used, thereby making it possible to prolong the lifespan of each portion of the deburring tool.

5. The deburring tool according to the item 1, wherein a diamond-like carbon film is formed on a surface of each of the protrusion and the blade portion, and
the diamond-like carbon film of the blade portion has higher hardness than the diamond-like carbon film of the protrusion.

According to this embodiment, a coating suitable for each location of the deburring tool is used, thereby making it possible to prolong the lifespan of each portion of the deburring tool.

6. The deburring tool according to the item 1, wherein the protrusion and the blade portion are formed separately.

According to this embodiment, since only the protrusion having a large thermal load can be replaced, cost reduction can be achieved.

7. The deburring tool according to the item 6, wherein the protrusion is configured to adjust a protruding amount thereof with respect to a ridge line of the blade portion.

According to this embodiment, it is possible to obtain an adjustment amount of the protrusion according to a welding depth.

8. The deburring tool according to the item 1, wherein a groove positioned between a flank surface of a cutting blade constituting the blade portion and a cutting blade following the flank surface is formed in an outer circumferential portion of the tool center portion.

According to this embodiment, air permeability between cutting blades can be improved, and a heat dissipation effect can be obtained.

The invention is not limited to the foregoing embodiments, and various variations/changes are possible within the spirit of the invention.

What is claimed is:

1. A deburring tool for cutting burr generated when members are welded to each other by friction stir welding, the deburring tool comprising:
a tool center portion contacting a welding portion; and
a blade portion formed on an outer circumference of the tool center portion to cut the burr,
wherein the tool center portion includes a protrusion protruding downward from a ridge line of the blade portion to control a burr cutting amount.

2. The deburring tool according to claim 1, wherein the protrusion protrudes downward from the ridge line of the blade portion in an arc shape.

3. The deburring tool according to claim 1, wherein the blade portion has a shape in which a distal end angle decreases toward an outer circumference thereof in a radial direction.

4. The deburring tool according to claim 1, wherein a diamond-like carbon film is formed on a surface of each of the protrusion and the blade portion, and
the diamond-like carbon film of the protrusion has a lower friction coefficient than the diamond-like carbon film of the blade portion.

5. The deburring tool according to claim 1, wherein a diamond-like carbon film is formed on a surface of each of the protrusion and the blade portion, and
the diamond-like carbon film of the blade portion has higher hardness than the diamond-like carbon film of the protrusion.

6. The deburring tool according to claim 1, wherein the protrusion and the blade portion are formed separately.

7. The deburring tool according to claim 6, wherein the protrusion is configured to adjust a protruding amount thereof with respect to a ridge line of the blade portion.

8. The deburring tool according to claim 1, wherein a groove positioned between a flank surface of a cutting blade constituting the blade portion and a cutting blade following the flank surface is formed in an outer circumferential portion of the tool center portion.
